(19) United States
(12) Patent Application Publication
(10) Pub. No.: US 2006/0190627 A1
(43) Pub. Date: Aug. 24, 2006

(54) Community network system with broadband integrated services

(76) Inventors: Zhimei Wu, Beijing (CN); Guiming Fang, Beijing (CN); Qiong Liu, Beijing (CN); Zhiqiang Shi, Beijing (CN); Dongchao Cheng, Beijing (CN)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 10/526,516

(22) PCT Filed: May 19, 2003
(86) PCT No.: PCT/CN03/00366

§ 371 Date: Apr. 3, 2006

(30) Foreign Application Priority Data
Sep. 9, 2002 (CN) 02129591.3
Oct. 10, 2002 (CN) 02131393.8

(51) Int. Cl. G06F 15/16

(52) U.S. Cl. 709/249

(57) ABSTRACT

A community network system with broadband integrated services includes video servers, video storages, video conference servers, satellite digital television receiver servers, a network accounting server, a network management server, Gigabit Ethernet Switches, Fast Ethernet switches, home gateways, wireless gateways, digital television sets, analogue television sets, computers, PCs with wireless interface, stationary IP telephones, and wireless IP mobile phones. The IP stationary phone can be connected between the Fast Ethernet switch and the home gateway, and also can be connected between the home gateway and the computer. The wireless gateway is connected to the mobile phone and a mobile device. The satellite digital television receiver server is connected to a satellite signal receiver antenna. The backbone Gigabit Ethernet Switch is connected to a Metropolitan Area Network via a 1000 Mbps or 100 Mbps port. The system simultaneously provides the services of digital television, Internet access of the computer and IP telephone. The present invention achieves the service integration of television network, telephone network and computer network, and the integration of wired and wireless networks, and ensures the qualities of various services, information security and reasonable accounting.

### BACKGROUND OF-THE INVENTION

1. Field of the Invention

This invention relates to an IP network, more particularly to a community network system with broadband integrated services, which simultaneously provides services of digital television, IP telephone and computer network. The system is a software-hardware integrated system adapted to families in a community, and also can be applied in campuses, enterprises and hotels.

2. Description of the Prior Art

In terms of broadband integrated service access function, an optional scheme can be xDSL, Cable Modem and FTTx+LAN, as well as broadband wireless access. Current xDSL scheme has an advantage of being able to use the existing telephone lines in premises, and a disadvantage of high cost. In telecommunication office, it is necessary to place xDSL devices whose number is the same with the number of users, and the transmission quality of telephone lines in a considerable ratio can not satisfy the requirements of xDSL services. Current cable modem scheme has an advantage of being able to use the existing bidirectional cables for cable television as the transmission medium, and a disadvantage in that since most of cables for cable television in China are unidirectional, and it will cost much to reconstruct them into bidirectional cables, and since the bandwidth of a upload channel is limited, it is difficult to avoid noises cased by a funnel effect. Another current scheme of directly copying an office LAN into a community can realize broadband network access, but cannot realize the service integration of television network, telephone network and computer network.

### SUMMARY OF THE INVENTION

An object of the present invention is to provide a digital television education and entertainment service, an IP telephone service and a computer network service for a family in a community, and to provide a network infrastructure for a community intelligent management and a digitalization of a community, and to provide a practical solution for achieving the service integration of television network, telephone network and computer network.

To achieve the above object, the present invention is implemented in a manner that it consists of a backbone Gigabit Ethernet Switch which is connected to other Gigabit Ethernet Switches via a 1000 Mbps port and is connected to video servers, satellite digital television receiver servers, video conference servers, a network accounting server, a network management server via a 1000 Mbps port or a 100 Mbps port; a Gigabit Ethernet Switch which is connected to a plurality of Fast Ethernet switches via a 100 Mbps port; a Fast Ethernet switch which is connected to a plurality of home gateways and wireless gateways via a 10/100 Mbps compatible port; a home gateway which is connected to a digital television, an analogue television, a computer and an IP telephone, wherein the IP telephone can be connected between the Fast Ethernet switch and the home gateway or between the home gateway and the computer; a wireless gateway which is connected to a wireless IP mobile phone and a PC with a wireless interface via a radio link; a video server which is connected to a video storage; a satellite digital television receiver server which is connected to an outdoor antenna for receiving satellite data signals; the backbone Gigabit Ethernet Switch also connected with a metropolitan area network via a 1000 Mbps port; and software system. The software mainly includes embedded operation system, routing protocol, multicasting protocol, QoS protocol, SNMP protocol, digital television reception and demultiplexing, video on demand system, network management for an access network and network accounting.

The satellite digital television receiver server and the community video server provide a program source of digital television for the community. The broadband fiber metropolitan area network is another program source of digital television, and these digital television data pass through the Gigabit Ethernet Switch and Fast Ethernet switch in the system and arrive at the home gateway and after being decoded thereon, are sent to the television set. The home gateway is connected to the user's computer and the IP telephone. The user's computer can access various servers in the community through the home gateway, the Fast Ethernet switch, the Gigabit Ethernet Switch, and can also enter the metropolitan area network so as to access servers in Internet. The computer with a wireless interface can access various servers in the community through the wireless gateway, the Fast Ethernet switch and the Gigabit Ethernet Switch, and can also enter the metropolitan area network so as to access servers in Internet. The IP telephone can be intercommunicated with IP telephones or wireless IP mobile phones in the community, and can also be intercommunicated with telephones in a public telephone network and mobile phones in a mobile phone network through a telephone gateway in the metropolitan area network. The wireless IP telephone can be intercommunicated with IP telephones or wireless IP mobile phones in the community, and can also be intercommunicated with telephones in a public telephone network and mobile phones in a mobile phone network through a telephone gateway in the metropolitan area network.

As compared with currently existing xDSL scheme and Cable Modem scheme, the present has the following advantages:

(1) It solves the problem of guarantee of a QoS of a real-time service in the network, so that a user in the community can simultaneously watch television, access Internet and make an IP telephone call, and each service can fulfill the quality of service accepted by the user.

(2) It solves the problem of separation of the users' information, so that each family can not obtain information of other families, and thus it solves the problem of information security as well.

(3) The cost of the system is low, and a solution for the service integration of television network, telephone network and computer network in a broadband environment is provided.

(4) The copyrights of software and hardware are owned.

### BRIEF DESCRIPTION OF THE DRAWINGS

FIG. 1 is a schematic diagram of devices connection in the community network system with integrated broadband services;

FIG. 2 is a diagram of the software structure of the community network system with integrated broadband services; and

FIG. 3 is an information flowchart of the community network system with integrated broadband services.

### DETAILED DESCRIPTION OF THE PREFERRED EMBODIMENTS

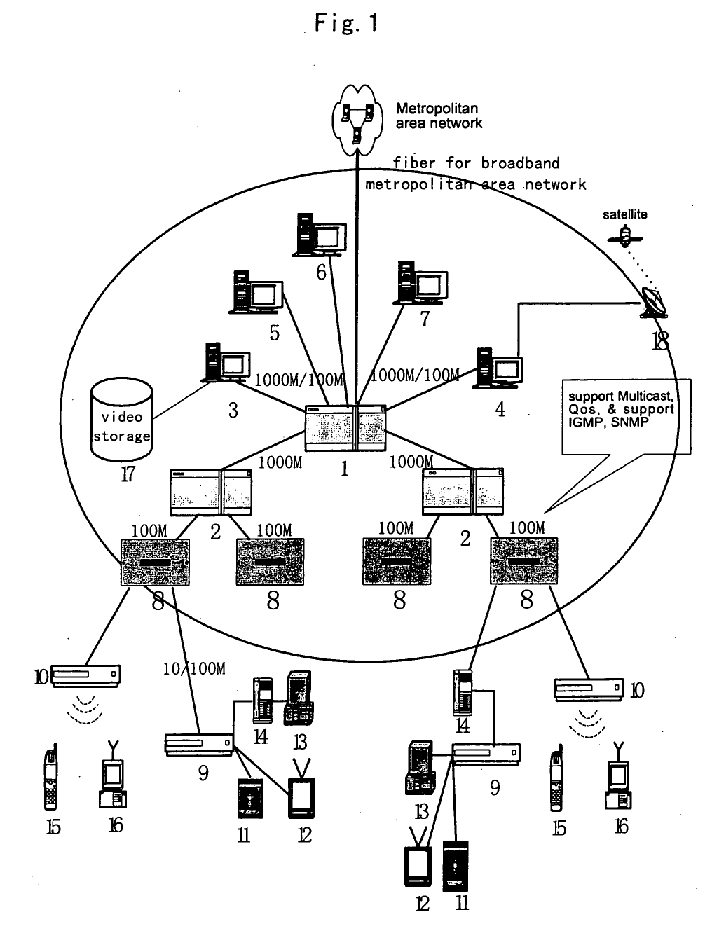

As shown in FIG. 1, the system is a network system adapted to be used in a community, a campus, an enterprise and a hotel, and supports broadband integrated services. A backbone Gigabit Ethernet Switch 1 is connected to other Gigabit Ethernet Switches 2 via a 1000 Mbps port and is connected to a video server 3, a satellite digital television receiver server 4, a video conference server 5, a network accounting server 6, and a network management server 7 via a 1000 Mbps port or a 100 Mbps port. The Gigabit Ethernet Switch 2 is connected to a plurality of Fast Ethernet switches 8 via a 100 Mbps port. The Fast Ethernet switch 8 is connected to a plurality of home gateways 9 and wireless gateways 10 via 10/100 Mbps compatible ports. The home gateway 9 is connected to a digital television 11, an analogue television 12, and a computer 13. An IP telephone 14 can be connected between the Fast Ethernet switch 8 and the home gateway 9 or between the home gateway 9 and the computer 13. The wireless gateway 10 is connected to a wireless IP mobile phone 15 and a PC 16 with a wireless interface via a radio link. The video server 3 is connected to a video storage 17. The satellite digital television receiver server 4 is connected to an outdoor antenna 18 for receiving satellite data signals. The backbone Gigabit Ethernet Switch 1 is also connected with a metropolitan area network via a 1000 Mbps port.

The hardware of the system mainly includes the satellite digital television receiver server, the community video server, the video conference server, the network accounting server, the network management server, the Gigabit Ethernet Switch, the Fast Ethernet switch, the home gateway, the digital television, the analogue television, the computer, the IP telephone, the wireless gateway, the wireless IP mobile phone, and the computer with a wireless interface. The hardware of the satellite digital television receiver server is an industrial PC with digital television receiver card which is connected to an outdoor antenna. The number of the satellite digital television receiver server in the system is dependent on the scale of the system. The video server may be one or more PC servers with disk arrays. The video conference server is composed of a PC, a video capture card, a camera, and a microphone. A PC functions as the network management server. And a PC functions as the network accounting server. According to the configuration, the Gigabit Ethernet Switch can provide 1 to 6 1000 Mbps ports or 8 to 48 100 Mbps ports. The Fast Ethernet switch provides 16 to 32 10/100 Mbps compatible ports. The home gateway provides two or more 10 Mbps or 10/100 Mbps ports, in which one port is connected to one Fast Ethernet switch, and the other ports are connected to the IP telephone or the home computer. A 15D type VGA interface, an S-Video interface, a composite video interface, a right sound channel interface and a left sound channel interface are used to send audio/video signals to a television set and an audio device. An infrared link is used to connect a remote control unit with a remote controller. The wireless gateway has one 10/100 Mbps compatible port connected to the Fast Ethernet switch, and 1-16 wireless channels used to connect with the wireless IP telephones or the PCs with a wireless interface.

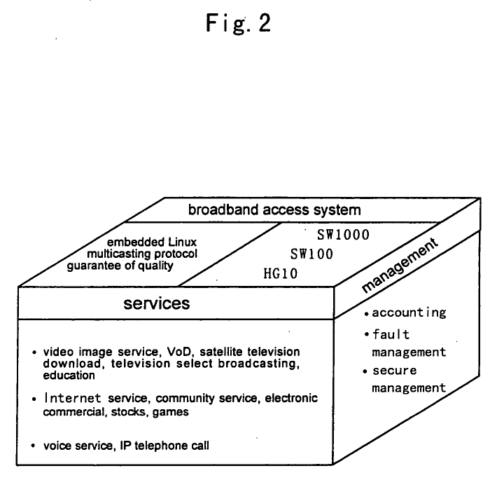

As shown in FIG. 2, the software of the system mainly includes system software such as embedded operation system, routing protocol, multicasting protocol, QoS protocol, SNMP protocol, network management for an access network, and network accounting; and application software such as a digital television reception and forwarding, a video on demand system, a computer network service, an IP telephone service. The embedded operation system on the Gigabit Ethernet Switch, the Fast Ethernet switch and the home gateway is an embedded system formed by customizing the system kernel on the basis of a Linux system. The operation system of the satellite digital television receiver server, the video server, the television conference server and the network management server maybe a Linux operation system or a Windows® system provided by Microsoft Corporation. The modules of multicasting software are distributed on the satellite digital television receiver server, the video server, the television conference server, the Gigabit Ethernet Switch, the Fast Ethernet switch and the home gateway, and they cooperate with each other, support IGMP protocol, and achieve a control to the multicast media streams. The modules of accounting software are distributed on the home gateway, the video server and the network accounting server, and the home gateway provides types of service, time of service and an amount of traffic used by the user. The network accounting server generates a bill according to an accounting strategy and the statistic data of the user. The modules of network management software are distributed in the network management server and all the network devices, and a configuration status, a running status and a failure status about devices are all detected and analyzed by the network management software.

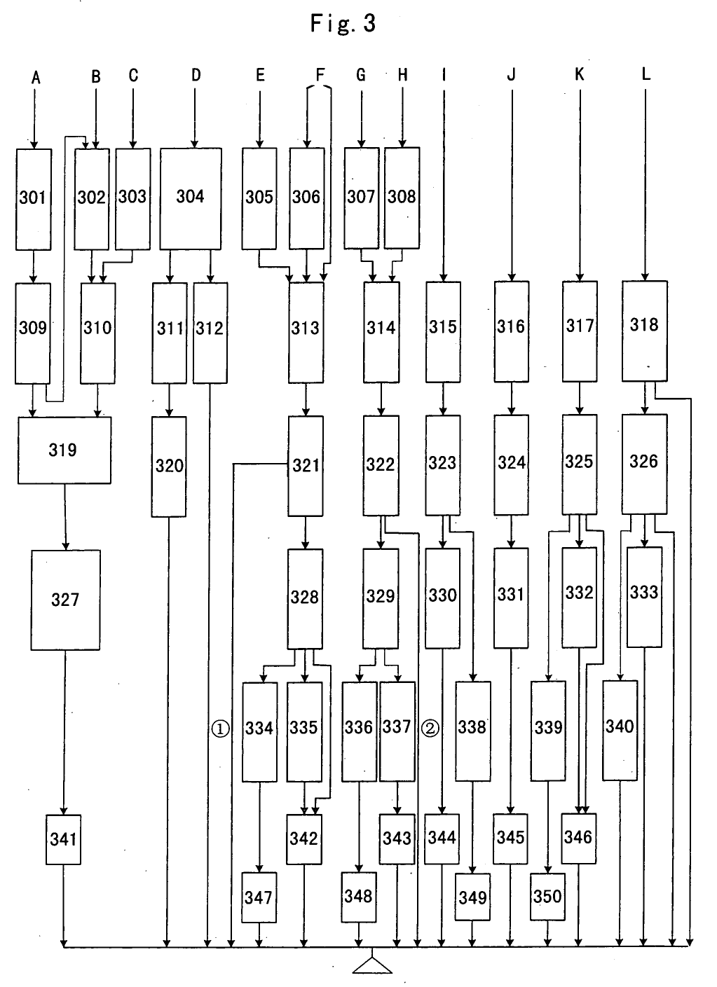

As shown in FIG. 3, in the present system, digital television program is received from the satellite, demultiplexed by the satellite digital television receiver server, and delivered to the home gateway through the Gigabit Ethernet Switch and the Fast Ethernet switch, and on the home gateway, video/audio data are decoded and a phase locking of the application layer is implemented, and then are sent to the television. The video from optical disks and the received digital television program are stored on the video server after compilation. When the user orders that, the information is played on the television sets through the switches and home gateway. After encoded by the video conference server, the information of video conference is played on the televisions sets or computers through the switches and home gateway. A multicast command from the remote controller or control panel is delivered to the switch by the home gateway, and then VLAN table is modified. A configuration command from the remote controller or control panel is used to modify the configuration of the home gateway. A local IP telephone call is forwarded to an IP telephone set or into the metropolitan area network through the home gateways and switches. A wireless IP mobile phone call is forwarded to a wireless IP handset or IP telephone set, or into the metropolitan area network through the wireless gateways and switches. The information from the local computer is forwarded to the computers through the home gateways and switches or is forwarded to the computers with wireless interfaces through the wireless gateways. The television program from the networks is forwarded by the switches, is decoded and phase locked on the home gateway, and is sent to television sets. The telephone call information from the networks is forwarded by the switches and home gateways and is sent to the telephone sets, or is forwarded by the switches and wireless gateways and is sent to the wireless IP mobile phone. The configuration information from the networks configures the switches, the home gateways or the wireless gateways.

The following functions are provided by the present system.

1. The system provides services such as digital television, IP telephone call and computer's accessing Internet for a user simultaneously.

2. The program source of the digital television may come from a satellite broadcast, the community video server or the metropolitan area network. The programs on the community video server may come from VCD, or may be derived from the storage and clipping of the satellite television programs. The programs on the metropolitan area network may come from the servers on Internet, or may be derived from the satellite television programs of other communities.

3. The program source encoding of the digital television may be a TS code stream of MPEG2 or a VCD code stream of MEPG1.

4. The service manners of the digital television include real-time play of the satellite television program, scheduled playback of the programs on the community video server, VoD playback of the programs on the community video server, and download of the programs from the community video server.

5. The system provides all functions of Internet access through the local area network for the users of the community.

6. The system provides the IP telephone service and IP mobile phone service in the community for the users of the community.

7. The system provides the users within the present community with the IP telephone service and IP mobile phone service to reach the users in another similar community through the metropolitan area network.

8. The system provides the users within the present community, with an IP telephone and wireless IP mobile phone service to reach PSTN telephones or mobile phones through an IP-PSTN gateway.

9. The system can provide other functions including property management, announcement of entertainment, announcement of commonweal activity, needs for help, etc.

10. The system provides the wireless access service of the PCs with wireless interfaces within a range of the community.

The performance indices of the present system are as follows.

1. The users in the community can simultaneously watch TV, surf Internet and make an IP call. The quality of the IP call is not lower than that presently provided by the telecommunication system. The quality of the television program is identical to that presently provided by the television network. When there are two services of telephone call and television, the service bandwidth of the users' accessing Internet is above 3 Mbps; and when the user does not watch TV, the service for accessing Internet is the same as that under the environment of the present office LAN.

2. There is no mosaic appearance in digital television within 2 hours in average. The average duration of the mosaic appearance is no more that 0.5 second.

3. The television channel switchover response is within 0.5 second, and the channel switchover is completed within 3 seconds. The VoD response is within 0.5 second, and the successful play begins within 3 seconds.

4. The speed phase locking of the application layer is processed on the home gateway so as to make the consuming speed of the media streams on the playing-end follow the generating speed of the media streams on the transmitting-end. An error accumulation caused by the inconsistence between the clock in the program source device and the clock in the home gateway is eliminated, so that when the program is multicast, it can be properly played on terminals with difference performances.

5. By using an asymmetric VLAN technique, the video multicast will be achieved through a unidirectional VLAN. The upstream information in the multicast group still belongs to different VLAN and the situation of user information broadcast in a usual VLAN should be avoided so as to achieve the separation of user information.

6. The users' identities are validated by means of IP addresses and MAC addresses of devices in the home gateway as well as VLAN numbers allocated in the system. The specific identification of a system administrator is verified by means of an electronic password. The satellite digital television receiver server, the video server, the property management server and the network accounting server in the community are protected by firewalls.

7. The objects to be charged are the users in the community and IP addresses. What should be considered in the accounting strategy are types of services, amounts of services, periods of services, and a discount is given to those users using large amounts of services and on holidays.

8. The parameters such as IP addresses, gateway addresses, network masks, television systems, the numbers of VLAN of a port and a VLAN number of a port can be configured to the Gigabit Ethernet Switch, the Fast Ethernet switch and the home gateway in a place where these devices are settled, or can be configured by using characters or Web interfaces through networks.

9. The SNMP protocol management numbers and the log parameters used by the system can be configured in a place where there devices are settled, or can be configured through networks.

### REFERENCE NUMERAL LIST OF FIG. 3

A—satellite digital television program
B—optical disc video image information
C—video conference information
D—remote controller or control panel information
E—wireless IP mobile phone information
F—stationary IP telephone information
G—information of PC with a wireless interface
H—information from computer
I—computer information from networks
J—television information from networks
K—telephone call information from networks
L—configuration information from networks
301—demultiplexed and demodulated by digital television receiver server
302—program are stored, edited and played by video server
303—conference information are edited by conference video server
304—multicast command is formed or parameters are configured by home gateway
305—voice data are forwarded by wireless gateway
306—voice data are forwarded by home gateway
307—computer data are forwarded by home wireless gateway
308—computer data are forwarded by home gateway
309—audio/video data are multicast by Gigabit Ethernet Switch
310—audio/video data are multicast by Gigabit Ethernet Switch
311—VLAN table of Gigabit Ethernet Switch is modified
312—configuration of home gateway is modified
313—voice data are forwarded by Fast Ethernet switch
314—computer data are forwarded by Fast Ethernet switch
315—computer data are forwarded by Gigabit Ethernet Switch
316—television data are forwarded by Gigabit Ethernet Switch
317—voice data are forwarded by Gigabit Ethernet Switch
318—this information is forwarded or configuration is performed by Gigabit Ethernet Switch
319—audio/video data are multicast by Fast Ethernet switch
320—VLAN table of Fast Ethernet switch is modified
321—voice data are forwarded by Gigabit Ethernet Switch
322—computer data are forwarded by Gigabit Ethernet Switch
323—computer data are forwarded by Fast Ethernet switch
324—television data are forwarded by Fast Ethernet switch
325—voice data are forwarded by Fast Ethernet switch
326—this information is forwarded or configuration is performed by Fast Ethernet switch
327—audio/video data are decoded by home gateway and phase locking of application layer is performed
328—voice data are forwarded by Fast Ethernet switch
329—computer data are forwarded by Fast Ethernet switch
330—computer data are forwarded by home gateway
331—television data are forwarded by home gateway
332—voice data are forwarded by home gateway
333—configuration of home gateway is modified
334—voice data are forwarded by wireless gateway
335—voice data are forwarded by home gateway
336—computer data are forwarded by wireless gateway
337—computer data are forwarded by home gateway
338—computer data are forwarded by wireless gateway
339—voice data are forwarded by wireless gateway
340—configuration of wireless gateway is modified
341—television set
342—stationary IP telephone set
343—computer
344—computer
345—television
346—stationary IP telephone set
347—wireless IP mobile phone
348—PC with a wireless interface
349—PC with a wireless
350—wireless IP mobile phone
\hat{1} entrance of metropolitan area network
\hat{2} entrance of metropolitan area network

What is claimed is:

1. A community network system with broadband integrated services which is composed of satellite digital television receiver servers, community video servers, video conference servers, network accounting servers, network management servers, Gigabit Ethernet Switches, Fast Ethernet switches, home gateways, digital television sets, analogue television sets, computers, IP telephones, wireless gateways, wireless IP mobile phones and PCs with a wireless interface, and which is characterized in that the backbone Gigabit Ethernet Switch of the system is connected to other Gigabit Ethernet Switches via a 1000 Mbps port, and is connected to the satellite digital television receiver server, the video server, the video conference server, the network accounting server, and the network management server via a 1000 Mbps port or a 100 Mbps port; the Gigabit Ethernet Switches are connected to a plurality of Fast Ethernet switches via a 100 Mbps port; the Fast Ethernet switches are connected to a plurality of home gateways and wireless gateways via 10/100 Mbps compatible ports; the home gateways are connected to the digital television, the analogue television, and the computer; the IP telephone is connected between the Fast Ethernet switch and the home gateway or between the home gateway and the computer; the wireless gateways are connected to the wireless IP mobile phone and the PC with a wireless interface via a radio link; the video server is connected to a video storage; the satellite digital television receiver server is connected to an outdoor antenna for receiving satellite data signals; the backbone Gigabit Ethernet Switch is also connected with a metropolitan area network via a 1000 Mbps port; and software system.

2. The system according to claim 1, wherein the satellite digital television receiver server is an industrial PC with digital television receiver card which is connected to an outdoor antenna; the video server may be one or more PC servers with disk array; the video conference server is composed of a PC, a video capture card, a camera, and a microphone; a PC functions as the network management server; a PC functions as the network accounting server; according to the configuration, the Gigabit Ethernet Switch can provide 1 to 6 1 000 Mbps ports or 8 to 48 100 Mbps ports; one 1000 Mbps interface module is exchangeable with eight 100 Mbps interface modules; the Fast Ethernet switch provides 16 to 32 10/100 Mbps compatible ports; the home gateway provides two or more 10 Mbps or 10/100 Mbps ports, in which one port is connected to one Fast Ethernet switch, and the other ports are connected to the IP telephone, the home computer or other devices; a 15D type VGA interface, an S-Video interface, a composite video interface, a right sound channel interface and a left sound channel interface are used to send audio/video signals to television sets and audio devices; an infrared link is between a remote control unit and a remote controller; the wireless gateway is connected to a plurality of mobile phones or mobile PCs wirelessly, and is connected to the Fast Ethernet switch or the Gigabit Ethernet Switch through one 10 Mbps or 10/100 Mbps port.

3. The system according to claim 1, wherein the software system mainly includes embedded operation system, routing protocols, multicasting protocols, QoS protocols, SNMP protocols, digital television reception and demultiplexing, video on demand system, network management for an access network and network accounting.

4. The system according to claim 1, wherein the system uses an asymmetric VLAN technique to achieve the separation of user information, and uses IP addresses and MAC addresses of devices in the home gateway as well as the VLAN numbers allocated in the system to validate the users' identities.

5. The system according to claim 1, wherein there is no mosaic appearance in the digital television sets within 2 hours in average; the average duration of the mosaic appearance is no more that 0.5 second; the television channel switchover response is within 0.5 second, and the channel switchover is completed within 3 seconds; the VoD response is within 0.5 second, and the successful play begins within 3 seconds.

6. The system according to claim 1, wherein the speed phase locking of the application layer is processed on the home gateway.
